(19) United States
(12) Patent Application Publication
(10) Pub. No.: US 2010/0245588 A1
(43) Pub. Date: Sep. 30, 2010

(54) TAG TRACKING SYSTEM

(75) Inventors: Glenn C. Waehner, Fresno, CA (US); Herbert W. Spencer, III, Valencia, CA (US)

Correspondence Address: Herbert W. Spencer III, 23629 Mill Valley Rd., Valencia, CA, 91355, US

(73) Assignee: ACUITY SYSTEMS INC., NEW WINDSOR, NY (US)

(21) Appl. No.: 12/750,590

(22) Filed: Mar. 30, 2010

Related U.S. Application Data
(60) Provisional application No. 61/165,097, filed on Mar. 31, 2009.

(51) Int. Cl. H04N 5/225

(52) U.S. Cl. 348/169; 348/E05.024

(57) ABSTRACT

A new system is described that integrates real time item location data from electronically tagged items with a video system to allow cameras in proximity to a tagged item to automatically be enabled or recorded and to move and follow the movement of the tagged item. The methodology to implement such a system is described and involves computerized coordinate system scaling and conversion to automatically select and command movement if available of the most appropriate cameras. The system can follow a moving tagged item and hand off the item from one camera to another, and also command other facility assets, such as lights and door locks.

This application is related to and claims the benefit of U.S. Provisional Patent Application Ser. No. 61/165,097 filed Mar. 31, 2009, entitled Tag Tracking System, the entirety of which is incorporated herein by reference.

### BACKGROUND OF THE INVENTION

Video system manufacturers have been trying to make movable (dome or pan/tilt) cameras follow specific subjects automatically, thus greatly reducing the work load of the guard. These devices can work in isolated cases, where very little activity exists in the image and only the lone moving object needs to be followed. However, in a busy store, or where the subject passes behind a post or other obstruction, the camera does not know what to do with very unsatisfactory results.

A new technology is emerging where tagged items located within some form of detection grid, can be located on a computer map in real time. As the tagged item or person moves within the detection grid, a symbol representing the tagged object moves on the computer generated map. This system does not depend on movement, and other activity is irrelevant. In some embodiments these items can also be identified by an item specific code to differentiate one from another.

Consider a casino where a key high roller is given a nice key chain, which is in fact a location tag. The casino will know exactly where this person is. In a similar way, valuable assets or objects can also be tagged and tracked. If a guard or security system operator can see the map, he can command cameras to record and follow any particular tag or group of tags.

### BRIEF DESCRIPTION OF THE DRAWINGS

The FIG. 1—Camera, Tag, Receivers, and Tracked Object—shows a tag system as are known to those skilled in the art for real time locating system (RTLS). The system outputs data defining the x and y coordinates (using the tag system map coordinates) of one or more tagged or identified items to be observed and or followed by the video system. The connection to the coordinate processor is typically a digital network, USB, or RS422 type communication link.

FIG. 2 Block Diagram Showing the Configuration for System Control of PTZ with a RTLS. This diagram shows the components of the system that would be typical for this invention.

### SUMMARY OF THE INVENTION

A real time locating system is used to provide coordinates that can select an appropriate camera to provide an image to a monitor of a selected item that periodically emanates a radio transmission signal by means of a tag or similar signal emitter. The emanation or tag can provide an identification information. The system can be programmed to determine if the tag is an item that needs to be displayed on a video monitor or can be ignored as a low priority event. If viewing is determined the following procedure is started. The data goes to a module that compares available camera coordinates in the camera system to the observed tag coordinates, and outputs the ID numbers or addresses of the cameras in proximity to the tag in question. This module also contains logic or tables that can logically compare possible camera fields of view against the tag location coordinates. The available camera field of view coordinates must be scaled and offset, and possibly coordinate converted to match the tag system so they can be compared to the tag coordinates to determine which cameras can see the tagged object. Pan and tilt or dome type movable cameras can include their full range of pan, tilt, and zoom as available for viewing. Multiple floors and buildings must also be accommodated in this comparison.

The identify and camera select module can also receive priority inputs so that the best of two or more cameras, or more than one of many possible cameras can be commanded to observe the object, allowing the lower priority units to possibly not be recorded or available for viewing a second tag. These priorities may also be stored in the camera data file. The identify module outputs commands to the video system to connect and view the selected cameras and to start recorders, turn on lights, open doors etc.

Once a camera is selected, if it is movable its identification must be sent to the convert and scale module. The specific tag coordinate system can be converted to the camera coordinate system and appropriate commands given to move the camera through the video camera control system. Alternately, the camera coordinate system can be converted to the coordinate system of the tags, and camera movement commands transmitted to the camera. This communication line, labeled camera movement commands, uses similar methods as the others and sends camera movement commands from the coordinate conversion system to the video system. Note that the convert and scale module movement command output can be filtered and smoothed so that the camera moves smoothly and does not exhibit jerky or erratic motion.

Both the identifier module and the coordinate converter/scalar module obtain data from one or more tables that store the location and field of view and coordinate system for each camera. This is shown as the camera data file.

### BRIEF DESCRIPTION OF RELATED TECHNOLOGY

The Robinson U.S. Pat. No. 6,700,493 describes a system for real time tracking of objects but does not disclose real time video tracking based on locating the object with his invention. U.S. Pat. No. 7,321,305 also describes a system for locating an object. The white paper “Virtual Security Shield”, Duos Technologies, Inc Jul. 24, 2008 discusses using RFID (radio frequency identification) and RTL (real time location) and then the use of a PTZ (pan, tilt, zoom) camera that is manual controlled by an operator to observe the object. This invention shows how this can be automated.

### DETAILED DESCRIPTION OF THE INVENTION

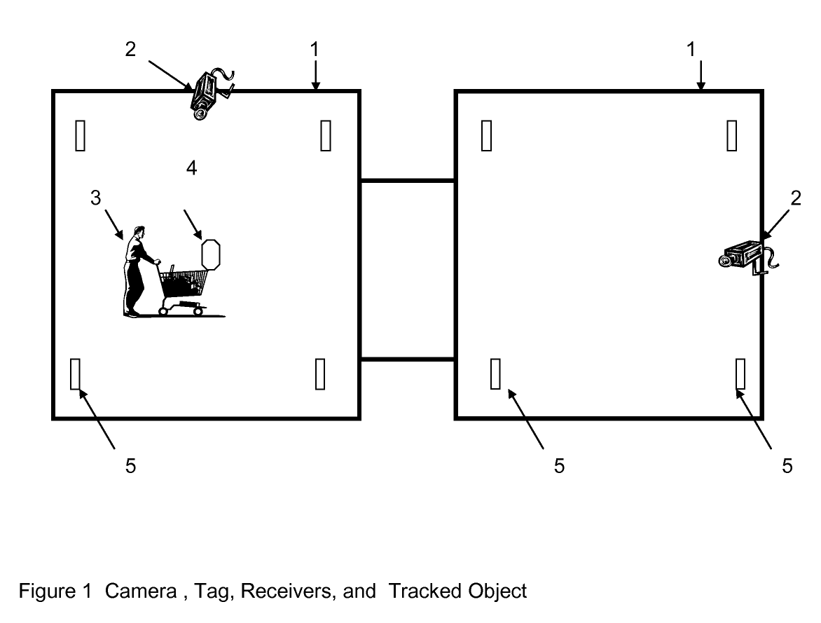

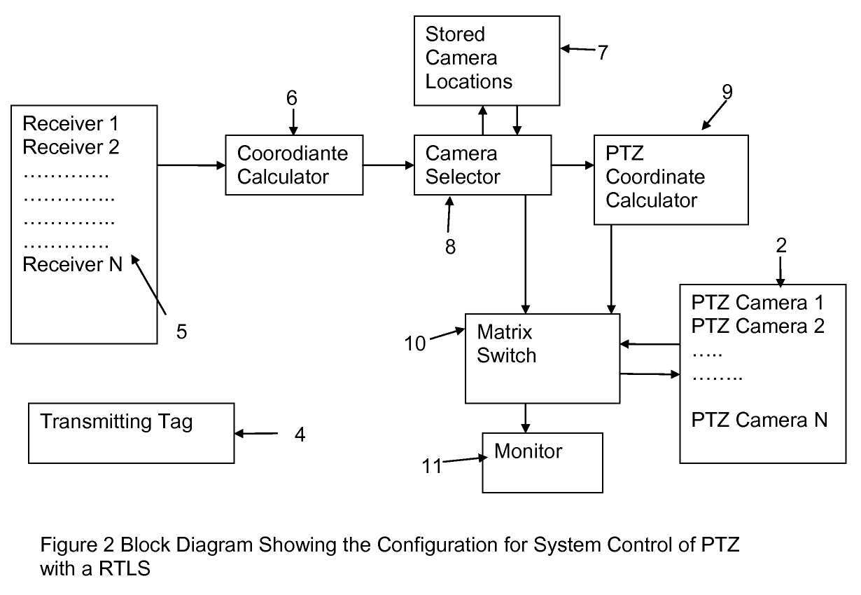

The concept is to integrate the position data from the tag system in a building, open area or rooms 1 into the video security management system as shown in FIG. 1 and FIG. 2, and directly command the closest camera or cameras to the tag to turn on and or start recording, turn on lights and lock or open doors, and or automatically move the camera to observe the coordinates given by the tag system as they change. The position data is determined from signals from a tag on an object received by receivers 5 and on position determined by various means including signal strength and triangulation. One way to accomplish the desired video observation would be to take the x and y coordinates from the computer map and compare these in the same coordinate system to a list by camera of possible coordinates that can be viewed. The search can start by comparing individual camera coordinates to the tag coordinates. The system can select the closest camera based on tag data from receivers 5 or all cameras that are within a given range, or the closest N cameras 4, or all that cover the tag 4 coordinates in any way, no matter how far away. There are other camera selection criteria that could be employed.

The movable cameras 2 can be commanded to move to place the tag 4 coordinates in the center of the field of view, or some offset of the field of view of the camera. The camera will move as the tag moves. Fixed cameras can either be turned on and or recorded if the tag is within the possible field of view of the camera. If the movable camera 2 receives roe and theta coordinates, the system will need to convert and associate the camera coordinate system 6, 7, 8, & 9 with the tag map coordinates. This can be accomplished exactly with a simple computer computation, or a table with reasonable granularity or resolution used to equate the map points with the camera points, or vice versa. Even with the same coordinate system, appropriate data scaling and offsets are required as are well known in the art. For example, zero for the dome is directly under it, but this is usually a non zero point on the tag map. A scaling and offset correction is still needed even if the camera coordinate system does match the tag system, as the point under the camera 2 will not likely equal the tag 4 coordinates.

A variety of smoothing algorithms well know in the art can be used to prevent rapid jerky motion of the cameras 2 when following the tag 4.

If the system is tracking two or more tags 4 at the same time, there is no conflict if the tags are physically separated and uniquely identifiable. However, if two tags are in the viewing range of one or more cameras 2, the system can select the closest camera to each tag first, and alternate between tags in making the next best camera selection for each tag. Alternately, if there is not enough camera coverage available, a priority system determined on setup can be established to select a camera for the highest priority tag first, the next camera for the next priority tag, etc.

The video stream from the selected camera 2 can be sent to a monitor 11. A virtual IP based switch or traditional analog matrix switch 10 can be used to connect the select the camera to the desired monitor and be used to send the PTZ coordinates to the selected camera.

For cost and installation savings reasons it is advantageous to employ the object tracking tag receivers in or adjacent to a camera assembly 2 and at the camera control or signal receiving location 5. This allows sharing or power wiring and adding the tracking signals into the camera signal or into the same system wiring (IE one wire or cable or fiber or wireless channel communicating both signals) to minimize wiring for the entire system. If the system is network based, providing both the video and the tracking system over the same communication connection with either the same or two separate network addresses.

Some of the key elements of the concept are:
Integrate data from the tag system into the video security management system to enable the security system to react to tag movement and position and take appropriate action with the security and facility systems such as cameras and lights and locks to name a few.
Convert video camera possible viewing coordinates to match the tag map system coordinates or alternately the tag system coordinates to the camera system coordinates.
Calculate proper scale factors and coordinate offsets to align cameras with the tag map.
Provide a smoothing method to give gradual movement of the cameras to facilitate viewing even if tag movement is jerky.
Identifying the best camera or cameras to use to track a tagged item, or not track based on programmed inputs or priorities.
Integrating the tag tracking system with video cameras to simplify installation, share communication means, and provide a more integrated solution.

What is claimed:

1. Employing an object tracking system using RF, IR, visible light (but not the camera image), GPS, acoustic or other x/y location technology as a real time location system (RTLS) to select one or more suitable cameras that contain the tracked object within their field of view or direct one or more movable or zoomable cameras to a suitable positioning to place the object within the field of view. Converting the coordinate systems of the object tracking system or cameras or both to enable a comparison of tag location with camera fields of view or available movable camera fields of view in real time to enable cameras that can see the object to be selected.

2. In claim 1 integrating data from the tag system into the video security management system to enable the security system to react to tag movement and position and select appropriate cameras, command movable cameras to observe or track tagged objects, turn on lights, activate locks, and take other appropriate actions available to the security and facility systems.

3. In claim 1 converting video camera field of view coordinates, PTZ coordinates, and tag system coordinates in a computing device to enable matching and selecting cameras that can view the tagged object.

4. In claim 1 calculating proper scale factors and coordinate offsets to coordinate and align cameras with the tag map.

5. In claim 1 provide a smoothing method to give gradual movement commands to the cameras to facilitate smooth viewing of the tagged object.

6. In claim 1 using settable priority rules to identify and select the best camera or cameras to use to observe or track a tagged item.

7. In claim 1 keeping a record of the possible field of view, movement coordinate system, wide angle field of view, long range telephoto zoom capability, and other capabilities of the available cameras in a memory device so that the system can determine which cameras have the capability to observe the object's reported location and make appropriate camera selections.

8. In claim 1 providing a means to enter and store a set of definable rules controlling camera selection, prioritizing and selecting more than one camera if more than one has good view of the location, and if a selected camera is movable or zoomable defining control actions such as but not limited to occasional reposition, movement speed, degree of zoom, etc.

9. In claim 1 employing an object tracking system in or adjacent to a camera assembly and at the camera control or signal receiving location. Adding the tracking signals into the camera signal or into the same camera system wiring or communication channels or if the system is network based, providing both the video and the tracking system over the same communication connection with either the same or two separate network addresses.

10. A real time locating system providing coordinates that can be used to automatically select an appropriate camera or cameras or provide tracking commands to one or more cameras to provide an image of a tagged item to a monitor.

11. In claim 10 integrating data from the tag system into the video security management system to enable the security system to react to tag movement and position and select appropriate cameras, command movable cameras to observe or track tagged objects, turn on lights, activate locks, and take other appropriate actions available to the security and facility systems.

12. In claim 10 converting video camera field of view coordinates, PTZ coordinates, and tag system coordinates in a computing device to enable matching and selecting cameras that can view the tagged object.

13. In claim 10 calculating proper scale factors and coordinate offsets to coordinate and align cameras with the tag map.

14. In claim 10 provide a smoothing method to give gradual movement commands to the cameras to facilitate smooth viewing of the tagged object.

15. In claim 10 using settable priority rules to identify and select the best camera or cameras to use to observe or track a tagged item.

16. In claim 10 keeping a record of the possible field of view, movement coordinate system, wide angle field of view, long range telephoto zoom capability, and other capabilities of the available cameras in a memory device so that the system can determine which cameras have the capability to observe the object's reported location and make appropriate camera selections.

17. In claim 10 providing a means to enter and store a set of definable rules controlling camera selection, prioritizing and selecting more than one camera if more than one has good view of the location, and if a selected camera is movable or zoomable defining control actions such as but not limited to occasional reposition, movement speed, degree of zoom, etc.

18. In claim 10 employing an object tracking system in or adjacent to a camera assembly and at the camera control or signal receiving location. Adding the tracking signals into the camera signal or into the same camera system wiring or communication channels or if the system is network based, providing both the video and the tracking system over the same communication connection with either the same or two separate network addresses.
